(19) United States
(12) Patent Application Publication
(10) Pub. No.: US 2005/0192962 A1
(43) Pub. Date: Sep. 1, 2005

(54) Apparatus, system, method for enabling web-applications to access enterprise managed data

(76) Inventors: Patricia Furrer, San Jose, CA (US); Cecilia Carranza Lewis, San Jose, CA (US); William Benjamin Nettles, San Jose, CA (US); Savur Anand Rao, San Jose, CA (US); Tony H. Xu, Santa Clara, CA (US)

Correspondence Address: KUNZLER & ASSOCIATES, 8 EAST BROADWAY, SUITE 600, SALT LAKE CITY, UT, 84111, US

(21) Appl. No.: 10/788,229

(22) Filed: Feb. 26, 2004

(51) Int. Cl. G06F 7/00

(52) U.S. Cl. 707/8

(57) ABSTRACT

An apparatus, system, and method are provided for enabling web-applications to access enterprise managed data. The invention includes a recoverable resource manager (RRM), a transaction converter, an interface, and a results converter. The RRM provides transactional recovery and transactional access for a plurality of applications including the web-applications. The transaction converter, interface, and results converter cooperate such that relational data requests sent by the web-application access the non-relational data through the RRM and return relational results from non-relational results provided by the RRM. In one implementation, the present invention provides transactional access to web-applications for VSAM data accessible exclusively through a z/OS operating system.

### BACKGROUND OF THE INVENTION

1. Field of the Invention

The invention relates to enterprise information systems. Specifically, the invention relates to apparatus, systems, and methods for enabling recoverable transactional access for web-applications to enterprise managed data.

2. Description of the Related Art

Computer and information technology continues to progress and provide tools that allow software applications to interact more easily than in the past. For example, web-applications and web services have been introduced recently to allow a client application such as a ubiquitous web browser to communicate over a world wide network, such as the World Wide Web, with a server application programmed to provide a variety of services including banking, shopping, remote access, database access, and the like. Typically, data for these services continues to be stored and maintained in a format originally defined when older computer technology first provided these services.

Today, modern interfaces allow the web-applications direct access to the data by way of a legacy data storage subsystem that maintains the original format and semantics for the data. Often, the legacy data storage subsystem is simply a file system of an operating system that manages a number of different files storing data in proprietary formats. One example of such data is Virtual Storage Access Method (VSAM) data accessible using the z/OS operating system from IBM. Large corporations, governments, and other enterprises continue to use such legacy data storage subsystems in order to benefit from significant financial investments that have been expended to develop and maintain the data and to allow legacy and/or modern applications to use the data.

Legacy data storage subsystems continue to manage a high percentage of the data and everyday transactions for these businesses. These modern interfaces avoid expensive data extraction, conversion, and reformatting costs generally associated with migrating data from a legacy system to a modern system. FIG. 1 illustrates one example of a system 100 that provides a direct interface for web-applications to legacy data.

The system 100 includes a web client 102, an application server 104, and legacy data 106 such as VSAM data 106. The web client 102 is one component in a web-application 108. Typically, the web-application 108 includes a number of modules including, but not limited to, web browsers, web services, applets, servlets, Enterprise Java Beans (EJBs), other web servers, middleware, and the like. Each of these alone, or in combination, may comprise a web-application 108. The web client 102 sends requests to access the VSAM data 106 over a network 110 such as the Internet.

One or more components of the web-application 108 execute within the application server 104. The application or web server 104 provides services such as security, authentication, and connection pooling for the web-application 108. The application server 104 operates within an operating system 112 such as Virtual Storage Extended/Enterprise Systems Architecture (VSE/ESA).

In conventional systems such as system 100, legacy VSAM data 106 is managed on the storage media by a file system within the operating system. The file system organizes and formats the data. Data is accessed by making calls such as a “GET” or a “PUT” call to the operating system which uses the file system to satisfy the request. Consequently, the VSAM data 106 is closely tied to the operating system.

The VSAM data 106 is stored in a non-relational format typically in flat files. Records in the VSAM data 106 are identified by keys and offset information into one or more files. The non-relational nature of the VSAM data 106 requires that relational transaction requests be translated into non-relational transaction requests.

The system 100 includes a VSAMSQL module 114 that translates between relational access methods, also referred to herein as relational transaction requests, and the non-relational access methods understood by the operating system for accessing VSAM data 106. The VSAMSQL module 114 allows a web-application 108 to access VSAM data 106 using Structured Query Language (SQL) relational transaction requests.

The VSAMSQL module 114 provides relational result sets in response to the requests. In this manner, a programmer for the web-application 108 is insulated from the details of older non-relational access methods. Instead, the programmer can use well-known SQL requests to access the VSAM data 106.

One example of system 100 is described in U.S. patent application Ser. No. 09/791,924 having publication number U.S. 2001/0018684A1 (hereinafter '684), commonly owned by the same assignee, and incorporated herein by reference. Unfortunately, a system 100 such as in application '684 does not provide the same transactional access and recovery functionality desired for today's mission critical transactions. Transactional access and recovery is not available because there is no data management system in place to interact with the VSAMSQL module 114. In addition, the VSE/ESA operating system does not support such management systems.

Consequently, the VSAMSQL module 114 interfaces directly with the operating system and file system. Records are locked on a file or record level with no guarantee that a particular transaction will complete as an atomic transaction, meaning one portion of the transaction may complete and change the data while a necessary second portion fails to update the data. Furthermore, if a transaction fails totally or partially, there are currently no mechanisms for recovering the transaction.

In addition, the file system interfacing with VSAMSQL does not provide other enterprise level data management functions such as two-phase commit, rollback, backup and recovery for this critical data. Web-application access to the VSAM data 106 using the VSAMSQL module 114 may result in lost data, data integrity problems, and/or data access limited to single requests due to locking of the data.

Accordingly, a need exists for an apparatus, system, and method for enabling web-applications to access enterprise managed data. The apparatus, system, and method should accept relational transactions through a standard interface and return relational results, even though the underlying data is non-relational. In addition, the apparatus, system, and method should provide transactional access and transactional recovery for legacy data managed to provide enterprise level features for a transaction such as two-phase commit, rollback, concurrent access, logging, and recovery.

### BRIEF SUMMARY OF THE INVENTION

The present invention has been developed in response to the present state of the art, and in particular, in response to the problems and needs in the art that have not yet been met for accessing legacy data using modern web-applications in which transactions initiated by the web-applications are protected by transaction recovery features including as two-phase commit, rollback, concurrent access, logging, and recovery. Accordingly, the present invention has been developed to provide an apparatus, system, and method for web-applications to access enterprise managed data that overcomes many or all of the above-discussed shortcomings in the art.

An apparatus according to the present invention includes a recoverable resource manager, a transaction converter, an interface, and a results converter. The recoverable resource manager (RRM) provides transactional recovery and transactional access for a plurality of transactions concurrently accessing the data. Preferably, the RRM is configured for a specific type of data such as Virtual Storage Access Method (VSAM) data. The RRM manages access to the data by a plurality of applications issuing transactional requests. Preferably, the RRM cooperates with other components in an Enterprise Information System (EIS) to provide logging, locking, two-phase commit, back out and sharing of the data such that transactions accessing the data are recoverable.

The transaction converter converts relational transaction requests from the web-application into one or more non-relational transaction requests. The relational transaction requests are for data managed by the RRM. The interface allows the non-relational transaction requests to be sent to the RRM to be executed in order to produce non-relational results that are returned to the interface. The results converter converts the non-relational results into relational results that can be sent back to the web-application. In certain embodiments, a web-application interface is provided that receives the relational transaction from the web-application according to an industry-accepted application programming interface (API).

A method of the present invention is also presented for web-applications to access enterprise managed data. In one embodiment, the method includes providing a recoverable resource manager (RRM) for data, the RRM configured to provide transactional recovery and transactional access for a plurality of transactions concurrently accessing the data. Next, a relational transaction involving the data managed by the RRM is converted into a non-relational transaction. The non-relational transaction is communicated to the RRM which executes the non-relational transaction to produce non-relational results. Finally, the non-relational results are converted into relational results that are sent to a web-application.

The present invention also includes embodiments arranged as a system, computer readable code, and an apparatus that comprise substantially the same functionality as the components and steps described above in relation to the apparatus and method. The features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a block diagram illustrating conventional access methods provided to allow access to non-relational legacy data by modern web-applications;

FIG. 2 is a schematic block diagram illustrating one embodiment of an apparatus for web-applications to access enterprise managed data in accordance with the present invention;

FIG. 3 is schematic block diagram of one embodiment of a VSAM connector in accordance with the present invention;

FIG. 4A is a schematic block diagram illustrating an Enterprise Information System (EIS) capable of interfacing with certain embodiments of the present invention;

FIG. 4B is a schematic block diagram illustrating a Recoverable Resource Manager (RRM) configured to interface with the present invention;

FIG. 5 is a schematic block diagram of a transaction converter in accordance with the present invention;

FIG. 6 is a schematic block diagram of an apparatus for enabling web-applications to access enterprise managed data;

FIG. 7 is a schematic block diagram of a system for web-applications to access enterprise managed data;

FIG. 8 is a schematic flow chart diagram illustrating a method for web-applications to access enterprise managed data; and

FIG. 9 is a schematic flow chart diagram illustrating a method for communicating non-relational transaction requests to a recoverable resource manager and receiving the non-relational results.

### DETAILED DESCRIPTION OF THE INVENTION

It will be readily understood that the components of the present invention, as generally described and illustrated in the figures herein, may be arranged and designed in a wide variety of different configurations. Thus, the following more detailed description of the embodiments of the apparatus, system, and method of the present invention, as presented in the Figures, is not intended to limit the scope of the invention, as claimed, but is merely representative of selected embodiments of the invention.

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions which may, for instance, be organized as an object, procedure, function, or other construct. Nevertheless, the executables of an identified module need not be physically located together, but may comprise disparate instructions stored in different locations which, when joined logically together, comprise the module and achieve the stated purpose for the module.

Indeed, a module of executable code could be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

Reference throughout this specification to “a select embodiment,” “one embodiment,” or “an embodiment” means that a particular feature, structure, or characteristic described in connection with the embodiment is included in at least one embodiment of the present invention. Thus, appearances of the phrases “a select embodiment,” “in one embodiment,” or “in an embodiment” in various places throughout this specification are not necessarily all referring to the same embodiment.

Furthermore, the described features, structures, or characteristics may be combined in any suitable manner in one or more embodiments. In the following description, numerous specific details are provided, such as examples of programming, software modules, user selections, user interfaces, network transactions, database queries, database structures, hardware modules, hardware circuits, hardware chips, etc., to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

The illustrated embodiments of the invention will be best understood by reference to the drawings, wherein like parts are designated by like numerals throughout. The following description is intended only by way of example, and simply illustrates certain selected embodiments of devices, systems, and processes that are consistent with the invention as claimed herein.

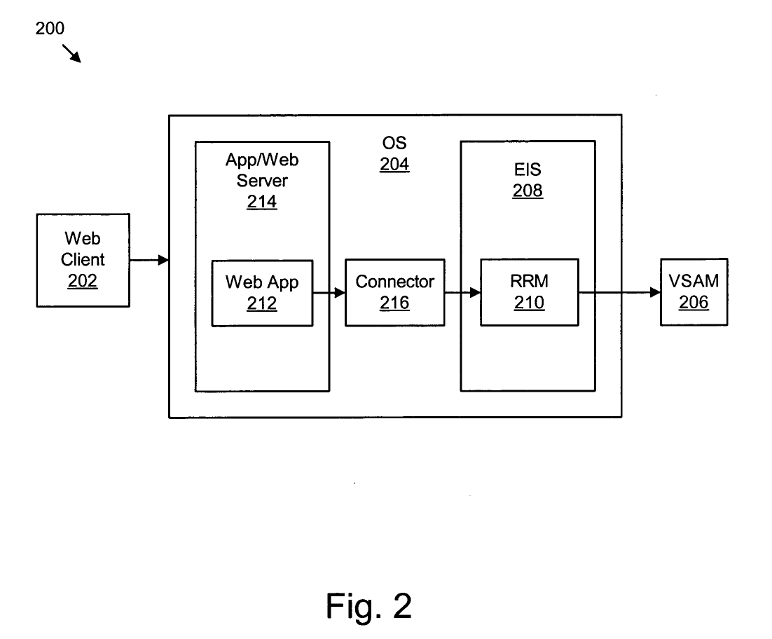

FIG. 2 illustrates an apparatus 200 for web-applications to access enterprise managed data in accordance with one embodiment of the present invention. The apparatus 200 includes a web client 202, an operating system 204, and at least one data store 206. Of course, the components of the apparatus 200 may execute on one or more computer systems connected by network communications.

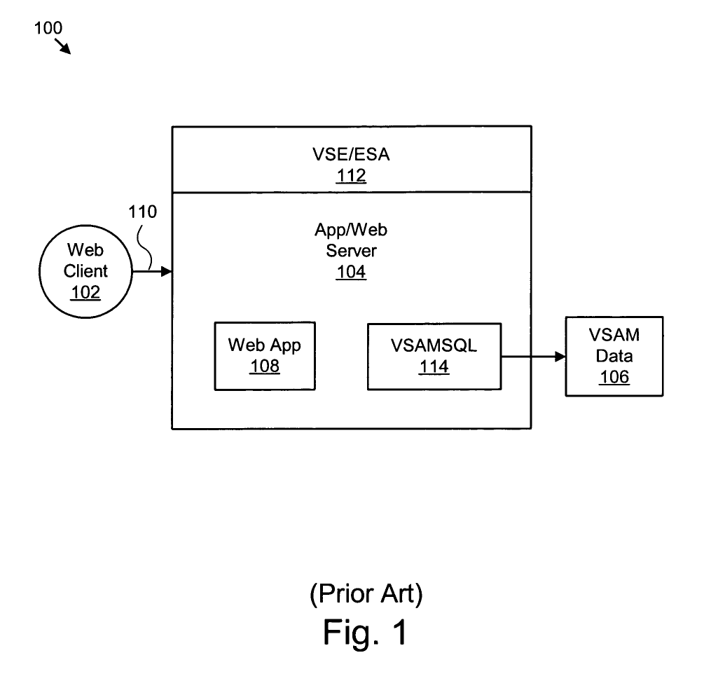

The web client 202 comprises a well-known component similar to the web client 102 discussed in relation to FIG. 1. The operating system 204 is known and may comprise any operating system including Linux, Unix, Windows, OS/390, z/OS, or the like.

As mentioned above, the data store 206 for certain legacy data often does not include logic or structures for maintaining the structure of individual records or data elements. Instead, an Enterprise Information System (EIS) 208 executing on the operating system 204 maintains the format, schema, and semantics for the data stored in the data store 206. Optionally or in addition, the EIS 208 may communicate with other data management modules to manage the schema and semantics for the legacy data.

An EIS 208 provides enterprise level features, functions, and protections for the legacy data. In addition to schema and semantic management, the EIS 208 may provide concurrent access. Historically, a batch process and a transaction process were unable to concurrently access the same records in the legacy data. Now, the EIS 208 allows either process to access the same data sets. Records and data elements are locked and unlocked as necessary to preserve data integrity.

In addition, the EIS 208 may log actions taken on the data. The logging may account for all updates to the data such that failed transactions may be backed out. Logging also allows the data store 206 to be recovered in the event of a system failure. The EIS 208 may include logic to ensure that atomic transactions are either completed or reversed so that data integrity is maintained. For example, the EIS 208 may provide two-phase commit functionality for the legacy data. Two-phase commit functionality ensures that all requests of a transaction either succeed together or fail together. Consequently, the EIS 208 provides modern database management features for legacy data accessible by a plurality of processes. The EIS 208 provides these advantages without requiring a modification of the storage format for the data or the code of the applications that have accessed the data.

Due to differences in format, structure, and semantics between legacy data stored on the data store 206, the EIS 208 may include a separate recoverable resource manager (RRM) 210 for each type of legacy data. A recoverable resource manager 210 comprises a software module designed specifically to manage the specific type of legacy data. The RRM 210 provides an interface between the EIS 208 and the particular type of legacy data. For example, one RRM 210 uses the schema, semantics, and protocols necessary to access and manage VSAM data in a VSAM data store 206. Similarly, other RRMs (not shown) in the EIS 208 may provide access to an Information Management System (IMS) data storage system and a DB2 data store 206.

The EIS 208 uses the RRMs 210 in conjunction with other components, discussed in more detail below, to provide enterprise management of legacy data. This is advantageous because it allows non-relational data such as VSAM data 206 stored in flat files to be used on modern transacitonal access methods such that the transactions are fully recoverable. Consequently, the VSAM data 206 does not have to be converted to a new file system and/or DBMS to remain useful to both modern and legacy applications.

Specifically, the RRMs 210 allow a plurality of applications concurrent transactional access to the legacy data in a manner that is recoverable, meaning transactional recovery is provided. As used herein, transactional recovery means that for any transaction between an external application and the data, the data is recoverable to its original state prior to initiating the transaction. A transaction comprises one or more transaction requests involving the data. A transaction request may read or update the data.

In addition to legacy applications, in certain embodiments of the present invention, the EIS 208 allows modern applications such as web-applications 212 and/or an application/web server 214 to access the legacy data with all the benefits of enterprise managed data. Web-applications 212 and application/web servers 214 are well known and generally include a standard interface (not shown) such as Open Database Connectivity (ODBC) for accessing data in a data store 206. To insulate the web-applications 212 and standard database connection modules from an RRM 210, the present invention provides a connector 216.

The connector 216 translates transactional requests between a web-application 212 and an RRM 210 of the EIS 208. Similarly, the connector 216 translates results provided by the RRM 210 into a format and protocol understood by the web-application 212. Preferably, a different connector 216 is associated with each type of legacy data in different legacy stores 206. Alternatively, a single connector 216 may communicate with a plurality of RRMs 210.

The web-application 212 sends a transaction request to the connector 216. Typically, the original transaction request is in a modern standardized format. The connector 216 generates one or more transaction requests that are understandable by the RRM 210. Rather than the connector 216 communicating directly with the operating system, file system or other legacy data management system, transaction requests pass through the RRM 210 such that the transaction obtains the benefits of data managed by the Enterprise Information System (EIS) 208.

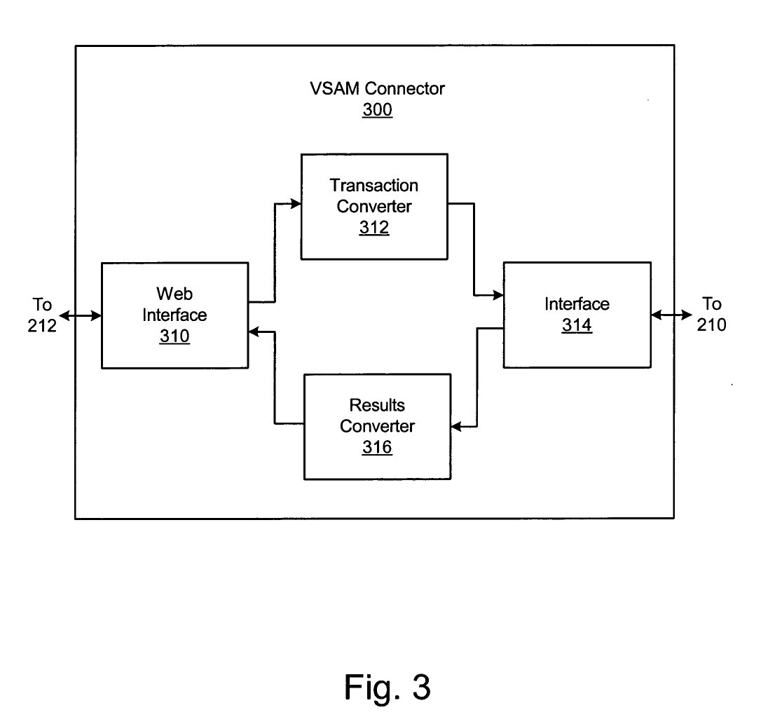

FIG. 3 illustrates one embodiment of a connector 300 according to one embodiment of the present invention. Specifically, the connector 300 enables transactions to obtain enterprise managed benefits when accessing VSAM data 206 by way of a VSAM RRM 210 (See FIG. 2). The VSAM connector 300 includes a web interface 310, a transaction converter 312, an interface 314, and a results converter 316.

Typically, web-applications 212 are accustomed to accessing data that is stored in a relational format. Consequently, the web interface 310 receives a relational transaction request from a web-application 212. The web interface 310 comprises a published interface for receiving relational transaction requests. Preferably, the published interface is an industry-accepted application programming interface (API) such as Java Database Connectivity (JDBC), ODBC, or the like. Consequently, the relational transaction request is formatted according to the SQL protocol. Of course, the API of the web interface 310 may be modified to accommodate new data request protocols without changing other components of the VSAM connector 300.

VSAM data is structured in a non-relational format which means that transaction requests issues to the RRM 210 must also be non-relational transaction requests. In this manner, the VSAM data remains intact; no conversion or reformatting is required; and legacy applications, and batch programs can all still access and use the VSAM data with all the safe guards of enterprise managed data. The transaction converter 312 converts a relational transaction request received from the web interface 310 into one or more non-relational transaction requests. The non-relational transaction requests are formatted and defined in a manner consistent with the transaction request interface of the RRM 210.

The interface 314 sends the non-relational transaction requests provided by the transaction converter 312 to the RRM 210. As mentioned above, typically, each connector 300 corresponds with a single RRM 210; however, this is not necessary. In FIG. 3, the interface sends the non-relational transaction requests to the VSAM RRM 210. The RRM 210 executes the non-relational transaction requests as though the requests came from any other legacy application requesting transactional recovery and access to VSAM data 206.

The interface 314 receives the non-relational results provided by the RRM 210. The non-relational results are then provided to the results converter 316. The results converter 316 accepts the non-relational results and converts the results into relational results that can be sent to a web-application 212. In certain transaction requests, the relational results correspond one-for-one with the relational requests. In other transaction requests, the results converter 316 may accumulate a plurality of non-relational results until a suitable relational results set can be generated for the corresponding relational request. Accordingly, the results converter 316 may communicate with the web interface 310 and/or transaction converter 312 to ensure that the proper number of non-relational results are received so that the relational results correspond to the relational transaction request.

Non-relational results are sets of data such as VSAM data organized and structured according to the formatting, encoding, and structure used by all applications (legacy, batch, etc.) accessing VSAM data. Consequently, the results converter 316 may change the structure, formatting, and encoding of the data in the results such that the relational results have the structure, formatting, and encoding expected by the web application.

For example, modern web applications 212 use data encoded according to an encoding format such as Unicode. VSAM data is typically stored on mainframe storage systems in the Extended Binary-Coded Decimal Interchange Code (EBCDIC) encoding format. Consequently, the results converter 316 converts data in the results from EBCDIC to Unicode. Similarly, the transaction converter 312 may convert any data elements in the relational transaction request from Unicode to EBCDIC.

Preferably, the relational results are provided to the web interface 310 which returns the results to the web-application 212 that initiated the relational transaction request. In this manner, a web-application 212 can issue relational transaction requests, receive relational results, and have the whole transaction operate concurrently with other transactions while protected for purposes of recovery and data integrity by the RRM 210 working with other components of an EIS 208 (See FIG. 2).

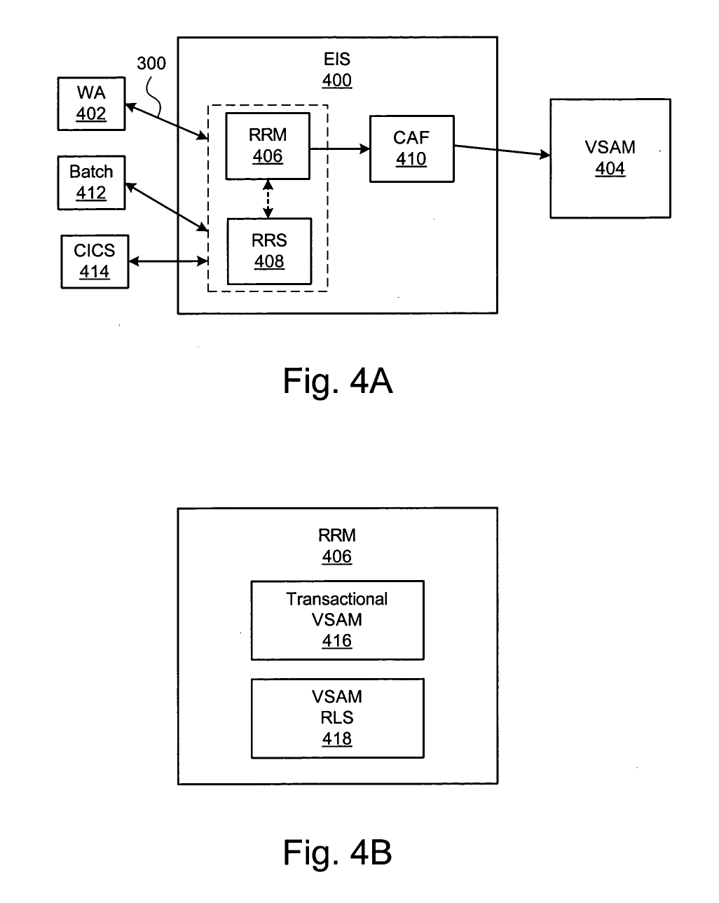

FIG. 4A illustrates one embodiment of an EIS 400 configured to function with the present invention such that web applications 402 benefit from transactional recovery of legacy data such as VSAM data 404. In certain embodiments, a recoverable resource manager (RRM) 406 provides logging, locking, two-phase commit, back out, and sharing of data such as VSAM data in a single component. Preferably, the RRM 406 cooperates with other components of the EIS 400 to provide these enterprise managed data benefits. The RRM 406 may provide a few of the enterprise data management features and rely on the other components of the EIS 400 for the additional features.

Preferably, the RRM 406 is substantially the same as the RRM 210 described in relation to FIG. 2. In one embodiment, the RRM 406 cooperates with a Resource Recovery Service (RRS) 408 and a Concurrent Access Facility (CAF) 410 to provide a full set of enterprise data management features including logging, locking, two-phase commit, back out, and sharing of data.

The RRM 406 in combination with the RRS 408 allows for recoverable transactional access to VSAM data 404. Preferably, the RRM 406 is used by batch applications 412, legacy applications 414 such as Customer Information Control System (CICS) 414, as well as web-applications 402. Batch and legacy applications 412, 414 may access the RRS 408 directly or through an RRM 406 specific to that program. In one embodiment, the RRM 406 comprises a Storage Management Subsystem for Virtual Storage Access Method (SMS VSAM) data available from International Business Machines (IBM).

Recoverable relational transactions from web-applications 402 are made possible by the connector 300 in conjunction with the RRM 406, RRS 408, and CAF 410. Of course, the batch and legacy applications 412, 414 send non-relational transaction requests directly to the RRS 408.

The CAF 410 allows the applications 402, 412, 414 to concurrently access the same VSAM data 404 at anytime of the day. None of the applications 402, 412, and 414 have to wait of go off-line to permit access to the VSAM data 404. The VSAM data 404 is cached and managed for concurrent access. In one embodiment, the CAF 410 comprises a Coupling Facility (CF) available from International Business Machines (IBM).

FIG. 4B illustrates an RRM 406 according to one embodiment of the present invention. The RRM 406 includes a transactional VSAM (TVS) module 416 and a VSAM Record Level Sharing (VSAM RLS) module 418. The TVS module 416 allows for transactional access to VSAM data by a plurality of applications 402, 412, 414. The TVS module 406 includes complex locking and logging mechanisms such that transactions involving VSAM data are fully recoverable.

To facilitate sharing of the VSAM data 404, the TVS module 416 uses the VSAM RLS module 418. The VSAM RLS module 418 allows multiple applications to share VSAM data at the record level. In one embodiment, the most recent release of transactional VSAM also known as DFSMStvs and VSAM RLS available from IBM may be used in the present invention.

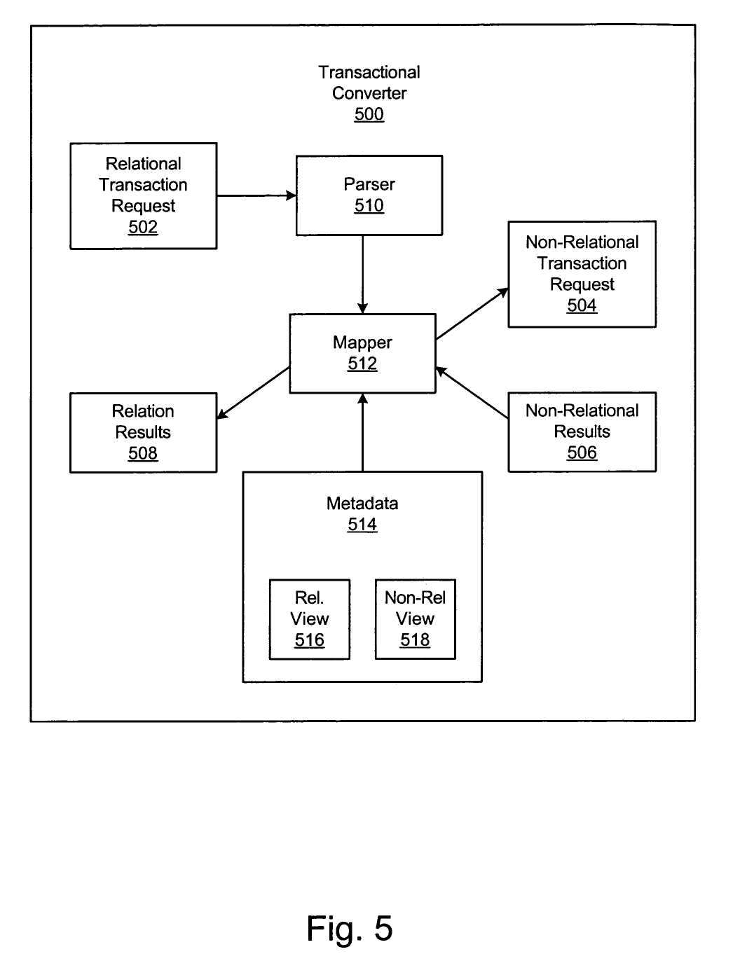

FIG. 5 illustrates one embodiment of a transaction converter 500. The transaction converter 500 may comprise a single module configured to perform essentially the same functions performed together by the transaction converter 312 and results converter 316 described above in relation to FIG. 3. The transaction converter 500 converts relational transaction requests 502 into non-relational transaction requests 504 and non-relational results 506 into relational results 508.

The converter 500 includes a parser 510, a mapper 512, and metadata 514. The parser 510 parses the relational transaction request 502 into one or more relational expressions. For example, suppose the relational transaction request 502 comprises a SQL statement such as “Select Name, Age From employees Where Age>=65.” The parser 510 parses the statement 502 into the expressions “Select Name, Age,” “From employees,” and “Where Age>=65” according to the keywords identified in the SQL protocol. The relational expressions are parsed and formatted according to a relational transaction protocol such as SQL. Of course any relational transaction protocol may be used.

Next, the mapper 512 maps the relational expressions into non-relational expressions. To perform the mapping, the mapper 512 preferably includes a set of rules (not shown, but may be stored in metadata 514) that indicate how the syntax of a relational expression is to be changed to produce the same syntax in a non-relational expression for accessing the data. The mapper 512 uses the rules to generate one or more non-relational expressions that correspond to each relational expression.

Next, the mapper 512 maps the data element identifiers and literal data elements in the relational expressions to corresponding data element identifiers and literal data elements for non-relational expressions. To perform this mapping, the mapper 512 may refer to a relational view 516 and a non-relational view 518.

Typically, the data referenced by the relational transaction request 502 is organized according to a different schema and encoding format than that used to formulate the relational transaction request 502 originally. Consequently, the relational view 516 stores the relational schema and encoding identifier while the non-relational view 518 stores the non-relational view 518.

The relational view 516 includes the names and characteristics such as label, size, and data type for the tables, columns, and fields that are to be accessed by relational transaction requests 502. The non-relational view 518 describes the datasets and records to the non-relational data such as VSAM data. The non-relational view 518 includes the labels, offsets, lengths, and data types for the data in the data records.

Preferably, the relational view 516 includes the same labels and identifiers for tables, columns, and fields as used in valid relational transaction requests 502. In this manner, the mapper 512 may map a relational expression by searching the relational view 516 for a matching table label, column label, or field label depending on what label is encountered in parsing each relational expression. Once a matching label is found in the relational view 516 a pointer or other identifier may indicate the corresponding label and section of the non-relational view 518. The mapper 512 may then use the pointer to look up the proper non-relational syntax and semantics for the matching label in the non-relational view 518. The mapper 512 proceeds in this manner to generate at least one non-relational expression for each relational expression.

If the relational expression includes a literal data element instead of a label, the mapper 512 may convert the literal data element to a corresponding data element with the encoding format of the non-relational data, such as VSAM data. For example, data elements in a relational expression may be encoded in Unicode and the non-relational data elements may be encoded in EBCDIC. Consequently, the mapper 512 converts the Unicode representation of the string into an EBCDIC encoding.

The relational and non-relational views 516, 518 may be organized and stored in any data structure. Preferably, the relational and non-relational views 516, 518 and other metadata 514 are stored in a file according to an eXtended Markup Language (XML). Using a modern data structure such as XML may allow for pre-built modules to be used in the mapper 512 to facilitate the mapping process. The relational and non-relational views 516, 518 must be defined prior to mapping relational transaction requests. If the mapper 512 fails to find a corresponding match an error event occurs. The relational and non-relational views 516, 518 may be generated manually or through the use of automated tools that are programmed to produce the proper XML files given a source schema such as a COBOL copybook.

In one embodiment, relational and non-relational views 516, 518 are defined for VSAM data. The VSAM data is stored according to a non-relational access method on a system using the EBCDIC encoding format. Typically, the non-relational access method for VSAM data organizes the data such that a VSAM dataset corresponds to a table in a relational access method. Similarly, each field in a VSAM data record corresponds to a column in the table and data in VSAM records correspond to data in the rows of the table.

In certain embodiments, the mapper 512 also converts the non-relational results 506 into relational results 508. Non-relational results 506 typically comprise either a success message, a failure message, or the requested data. Preferably, the mapper 512 is programmed to translate success and failure messages from a non-relational format to a relational format. Of course translation of these messages may not be necessary as universal messages such as 1 for true and a 0 for failure may be used. Typically, the mapper 512 converts the requested data from a non-relational encoding format to a relational encoding format. However, the mapper 512 may reference the relational view 516 in order to properly format a field of data in the result set or to convert the data type. For example, a binary non-relational data element of 180 characters may map to a data field in the relational view of type string with a maximum length of 100 characters. Consequently, the mapper 512 may perform the data type conversion and truncate the resulting string to 100 characters.

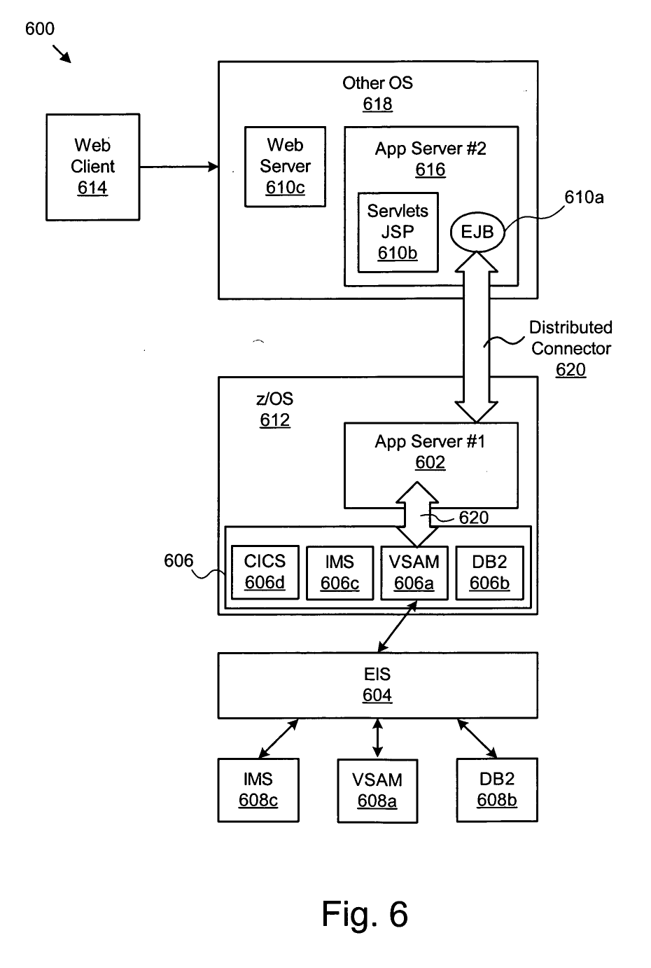

FIG. 6 illustrates one embodiment of an apparatus 600 for web-applications to access enterprise managed data. The apparatus 600 includes a first application server 602, an EIS 604, and one or more connectors 606. Preferably, each connector 606 interfaces with a particular type of data in a particular data store 608a-c. In particular, the apparatus 600 is configured to allow a single transaction to use data in a plurality of data stores 608a-c such that the transaction benefits from transactional recovery and transactional access provided by the EIS 604.

For example, a web-application 610, or component thereof, executing on the first application server 602 may issue transaction requests for VSAM data, IMS data, and/or DB2 data all within the same transaction. The EIS 604 coordinates and manages the locking, logging, two-phase commits, and sharing of the data to ensure that the transaction is fully recoverable even though a plurality of data sources are accessed.

The first application server 602, EIS 604, and connectors 606 interact and function in similar manner to the corresponding application/web server 214, EIS 208, and connectors 210 of the apparatus 200 of FIG. 2. The apparatus 600 illustrates how a single transaction may involve a plurality of connectors 606.

In particular, the EIS 604 includes an RRM 210 (See FIG. 2) specifically configured to manage recoverable transactions involving VSAM data. The apparatus 600 includes a VSAM connector 606a configured to exchange relational requests and relational results for VSAM data between the first application server 602 and the RRM 210 of the EIS 604. In one embodiment, the RRM 210 interfaces with a Storage Management Subsystem for Virtual Storage Access Method data (SMSVSAM) data, a coupling facility (CF), and a VSAM Record Level Sharing module in order to provide logging, locking, two-phase commit, back out, and sharing of the VSAM data for recoverable transactions.

Preferably, the connectors 606 are configured to bridge between legacy data management systems such as EIS 604 and modern technologies such as web-applications 610 and/or web components 610. Consequently, in certain embodiments, the connectors 606 are implemented using standardized Application Programming Interfaces (APIs) such as, but not limited to, the Java Database Connectivity (JDBC) API.

The connectors 606 comprise an technology insulation layer between web-application 610 and Application/web-server 602 technology on one side and legacy applications, operating systems, and/or system calls on the other. Consequently, the connectors 606 function much like software drivers insulate an application from particular hardware commands. Different types of connectors 606 may be implemented. For JDBC connectors 606, four different well known types exist.

Type-1 connectors comprise a JDBC-ODBC bridge. Type-2 connectors comprises a native API combined with a driver written partially in the JAVA programming language. A type-2 connector converts JDBC calls into database or operating system specific data requests. In certain embodiments, the VSAM connector 606a comprises a type-2 connector written in JAVA and a language compatible with the host operating system 612 such as the z/OS from IBM. A type-3 connector comprises a driver written completely in JAVA that passed JDBC requests through a network to a middle-tier server which then translates the JDBC request into a data store specific data request. A type-4 connector is written completely in JAVA and converts JDBC calls into a specific database management system protocol (DBMS) for direct communication with the DBMS server.

Referring still to FIG. 6, the apparatus 600 is readily extendable to a web-application software architecture that includes a plurality of tiers between the web client 614 and the EIS 604 managing access to the data to satisfy transactions. In one embodiment, rather than the entire web-application 610 executing on the first application/web server 602, the web-application 610 may be distributed on a plurality of servers. Certain components of the web-application 610 may execute on the first application/web server 602 as a web service or data server.

In the illustrated apparatus 600 of FIG. 6, a web-application 610 may comprise a plurality of distributed application components 610a-d. For example, a second application server 616 may execute various distributed application components 610a-c including Enterprise Java Beans (EJBs) 610a, Java Server Pages (JSPs) and/or servlets 610b and a web server 610c.

Preferably, the second application server 616 and distributed application components 610a-c execute on an operating system 618 other than the operating system 612 executing the VSAM connector 606a. In this manner, the VSAM connector 606a may execute on an operating system 612 such as z/OS 612 that includes native calls to access legacy data such as VSAM data 608a, while the remaining web-application components 610a-c operate one or more different operating systems 618 and still benefit from transactional recovery and access to legacy data such as VSAM data 608a. The different operating systems 618 may comprise Linux, Unix, Windows, Macintosh, BSD, and the like.

The distributed web-application components 610a-c communicate with the VSAM connector 606a by way of a distributed connector 620. The distributed connector 620 ensures that relational transaction requests for VSAM data from one or more web-applications 610 are communicated over a network to the VSAM connector 606a. The relational requests and relational results may pass through the first application server 602 to the VSAM connector 606a or are communicated directly to the VSAM connector 606a.

The distributed connector 620 may include one module executing on the first application server 602 and a corresponding module executing on the second application server 616. In one embodiment, the distributed connector 602 comprises a type-3 connector written in the JAVA programming language.

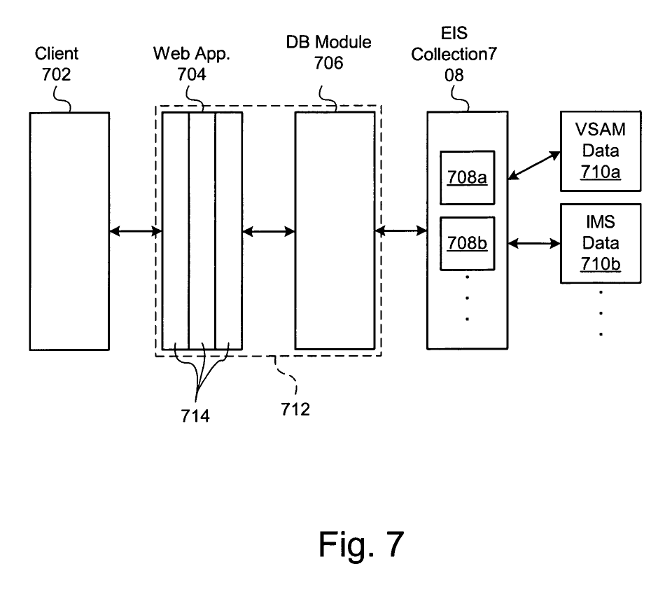

FIG. 7 illustrates a system 700 for web-applications to access enterprise managed data. Enterprise managed data refers to data that is concurrently available using transactional access methods and fully recoverable. Enterprise managed data is fully recoverable regardless of whether the data is accessed using a file system, operating system, or database management system. The enterprise managed VSAM data is particularly beneficial because access to VSAM data using such components as VSAMSQL, available from IBM, does not provide recoverable transactional access. FIG. 7 does not include certain details of the modules in order to more clearly present the data flow between the VSAM data and other legacy data stores and a web-application.

The system 700 includes a client application 702, a web-application 704, a database module 706, a collection of EISs 708, and a plurality of data stores 710. The client application 702 is well known and interfaces with the web-application 704. Preferably, the web-application 704 executes on a first application server 712. In one embodiment, the first application server 712 executes on a z/OS operating system.

The web-application 704 may comprise one or more distributed middleware components 714. The middleware components 714 may comprise servlets, JSPs, servers, Dynamic Link Libraries (DLLs), scripts, and other similar components that cooperate to form the web-application 704. Furthermore, the middleware components 714 may execute on one or more application servers.

The database module 706 is configured to provide relational database access to the data stores 710 which may or may not be relational data stores 710. Typically, web-applications 704 issue data requests strictly in a relational semantics. The database module 706 provides direct access to non-relational data stores 710 such as a VSAM data store 710a.

Web-applications 704 for an enterprise, however, may require that transactions involving the non-relational data 710 also be recoverable and that the non-relational data 710 be available anytime. Consequently, the database module 706 interfaces with the collection of EISs 708 that provides concurrent transactional access and transactional recovery for the web-application 704. At the same time, the one or more EISs 708a-n provide transactional recovery and transactional access to the same data for other applications such as batch programs, stored procedures, and legacy applications such as a Customer Information Control System (CICS).

Typically, the collection of EISs 708 is a preexisting system and the database module 706 is programmed specifically to interface with the specific EISs 708a-n. In certain embodiments, the database module 706 comprises a distributed connector linking a distributed application component to a connector operating on the same operating system as the collection of EISs 708a-n. The distributed embodiment of the database module 706 may operate similar to the distributed components described in relation to FIG. 6.

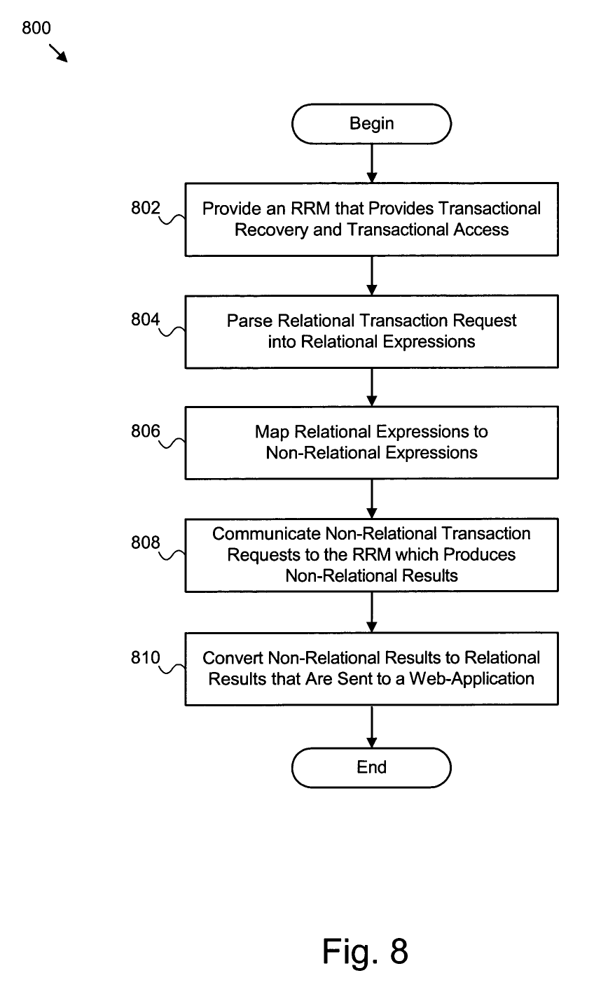

FIG. 8 illustrates a flow chart of a method 800 for web-applications to access enterprise managed data. The method 800 begins by providing 802 a recoverable resource manager (RRM) for data. Referring to FIGS. 2, 4A, and 8, the RRM 210/406 provides transactional recovery and transactional access for a plurality of transactions concurrently accessing the data.

As described above, transactional recovery allows a web-application 402 to access the data using a transactional access method. The transaction has features such as two-phase commit, logging, locking, back out, and sharing that are conventionally provided by a database management system (DBMS). Conventional solutions such as VSAMSQL allow a web-application to access VSAM data but do not provide the transactional recovery benefits similar to those available using the present invention. The present invention allows web-applications to access legacy data with the same protections available in modern DBMSs.

Initially, a web-application 402 sends one or more relational transaction requests 502 for a relational transaction to a transaction converter 500 (See FIG. 5). A parser 510 then parses 804 a relational transaction request 502 into one or more relational expressions. Next, a mapper 512 maps 806 the relational expressions to non-relational expressions and combines the non-relational expressions into non-relational transaction requests 504. Preferably, the mapper 512 uses predefined metadata 514 to perform the mapping.

In one embodiment, the connector 216 communicates 808 the non-relational transaction requests 504 to the RRM 210 (See FIG. 2). The RRM 210 produces non-relational results 506. In certain embodiments, the mapper 512 of a transaction converter 500 may also receive the non-relational results 506. The mapper 512 may use the same metadata 514 to convert 810 the non-relational results 506 into relational results 508. The relational results 508 are then provided to the web-application 402.

Of course the method 800 may be modified by those of skill in the art without departing from the essence of the present invention. All such modifications are considered within the scope of the present invention. In one embodiment, the RRM 210 cooperates with a Resource Recovery Service (RRS) and a Concurrent Access Facility (CAF) such that both relational and non-relational transactions managed by the RRM 210 are recoverable. The web-application 402 may communicate relational transactions to a connector 216 according to an industry-accepted API such as ODBC, JDBC, or the like.

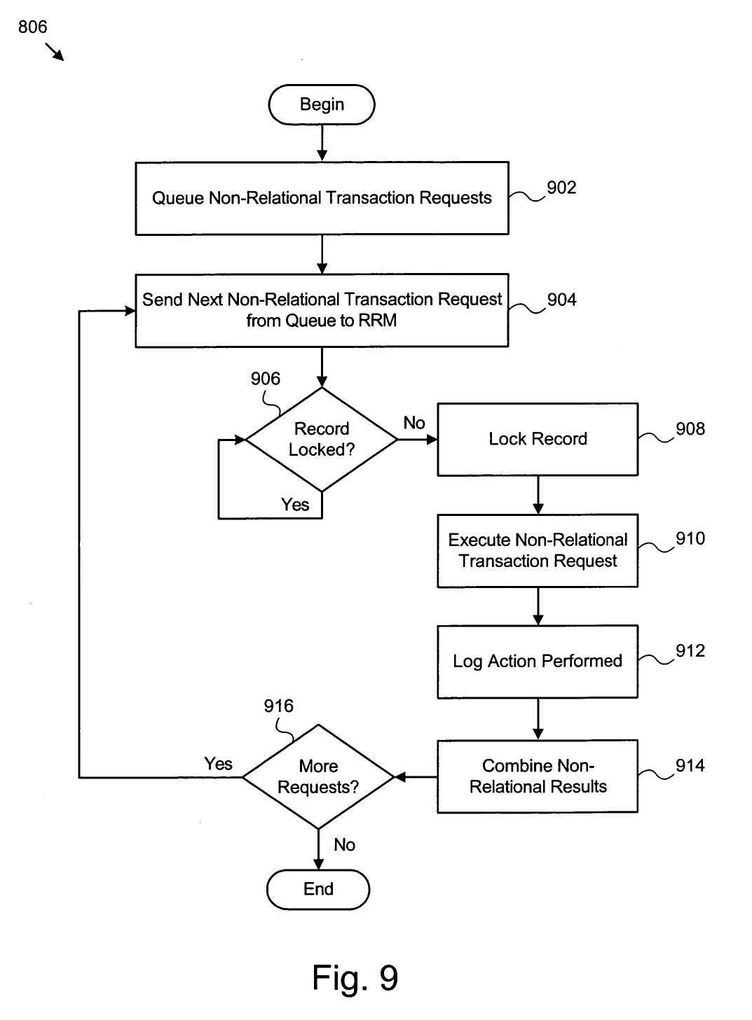

FIG. 9 illustrates further details of the process 806 of communicating non-relational transaction requests to the RRM 210 and receiving the non-relational results. The process 806 begins by queuing 902 up the non-relational transaction requests generated by the transaction converter 500. In certain embodiments, the transaction requests may be temporarily stored in a queue of the connector 216.

Next, the connector 216 sends 904 a first, or subsequent, non-relational transaction request from the queue to the RRM 210. Preferably, the connector 216 communicates with the RRM 210 using the same interface that native applications such as batch programs interfacing with the RRM 210. Consequently, the non-relational transaction request from the connector 216 receives the same treatment as other non-relational requests.

For example, if the non-relational transaction request includes access to a data record currently locked 906 for updating by another non-relational transaction request, the non-relational transaction request from the connector 216 waits until the lock is freed. Next, the RRM 210 permits access to the record. If non-relational transaction request from the connector 216 involves an update, the RRM 210 may lock 908 the record until the non-relational transaction request is executed 910. For example, the non-relational transaction request may comprise a GET or a PUT command. The RRM 210 may lock 908 the particular data record, for example a VSAM record, using a module such as a VSAM RLS module 418 (See FIG. 4).

If the non-relational transaction request is not an update, the non-relational transaction request is simply executed 910 and non-relational results are generated. Thereafter, the actions performed by the non-relational transaction request are logged 912.

For certain non-relational transaction requests in certain embodiments, the non-relational results are combined 914 into a single data set that may be sent once all relate non-relational transaction requests have been executed. For example, a relational request from a web-application may comprise a join operation between two or more tables. Once converted to non-relational transaction requests, a first set of non-relational transaction requests may deal exclusively with a first data set accessible through the RRM 210 and a second set of non-relational transaction requests may deal exclusively with a second data set accessible through the RRM 210. Consequently, non-relational results from the first data set may be combined 914 with non-relational results from the second data set in order to satisfy the desired join operation.

Next, a determination 916 is made whether more non-relational requests are in the queue. If so, the method 806 continues with step 904. If not, the method 806 ends.

In summary, the present invention provides an apparatus, system, and method for enabling web-applications to access enterprise managed data. The present invention interconnects modern web-applications with conventional enterprise data management systems such that legacy data such as VSAM data is transactionally accessible and that such transactions are fully recoverable. The present invention handles conversion of relational data requests in a relation transaction to non-relational data requests sent to the Recoverable Resource Manager (RRM) of the EIS tasked with managing data access to a particular type of data. The present invention uses a standard interface to the web-application. The apparatus, system, and method also provides transactional access and transactional recovery which includes enterprise functions such as two-phase commit, rollback, concurrent access, logging, and recovery.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. An apparatus for web-applications to access enterprise managed data, the apparatus comprising:
a recoverable resource manager (RRM) for data, the RRM configured to provide transactional recovery and transactional access for a plurality of transactions concurrently accessing the data;
a transaction converter configured to convert a relational transaction request of a transaction involving the data managed by the RRM into one or more non-relational transaction requests;
an interface configured to send the non-relational transaction requests to the RRM to be executed in order to produce non-relational results that are received by the interface; and
a results converter configured to convert the non-relational results into relational results that can be sent to a web-application.

2. The apparatus of claim 1, wherein the RRM cooperates within an enterprise information system (EIS) to provide logging, locking, two-phase commit, back out and sharing of the data such that transactions accessing the data are recoverable.

3. The apparatus of claim 1, further comprising a web-application interface configured to receive the relational transaction from the web-application according to an industry-accepted application programming interface (API).

4. The apparatus of claim 1, wherein the RRM cooperates with a resource recovery service (RRS) and a Concurrent Access Facility (CAF) such that relational and non-relational transactions accessing the data are recoverable.

5. The apparatus of claim 4, wherein the RRM comprises Storage Management Subsystem for Virtual Storage Access data (SMS VSAM) and the CAF comprises a coupling facility (CF).

6. The apparatus of claim 1, wherein the RRM comprises a transactional Virtual Storage Access Method (VSAM) module that uses VSAM Record Level Sharing (RLS) module and the data comprises VSAM data.

7. The apparatus of claim 1, wherein the transaction converter is further configured to parse the relational transaction into relational expressions and map the relational expressions to non-relational expressions according to predefined metadata defined by a relational view and a non-relational view of the data.

8. The apparatus of claim 1, wherein the results converter is further configured to map the non-relational results to relational results according to predefined metadata defined by a relational view and a non-relational view of the data.

9. An apparatus for web-applications to access enterprise managed data, the apparatus comprising:
a first application server configured to interface with a web-application;
an enterprise information system (EIS) comprising a recoverable resource manager (RRM) for Virtual Storage Access Method (VSAM) data, the RRM configured to provide transactional recovery and transactional access for a plurality of transactions concurrently accessing the VSAM data; and
a connector configured to exchange one or more relational requests of a transaction involving the VSAM data and relational results between the first application server and the RRM of the EIS.

10. The apparatus of claim 9, wherein the connector comprises:
a transaction converter configured to convert the relational requests into one or more non-relational requests;
an interface configured to send the non-relational requests to the RRM to be executed in order to produce non-relational results, the interface receiving the non-relational results; and
a results converter configured to convert the non-relational results into relational results that the connector sends to the web-application via the first application server.

11. The apparatus of claim 9, wherein the connector comprises a Java Database Connectivity (JDBC) Application Programming Interface (API).

12. The apparatus of claim 9, further comprising a second application server in communication with the first application server, the apparatus further comprising a distributed connecter that interfaces between a distributed application component on the second application server and the connecter executing on the first application server such that the distributed application component has transactional access to the VSAM data in which the transactions are managed using transactional recovery.

13. The apparatus of claim 12, wherein the distributed connector comprises a JAVA programming language type-3 connecter and the connector comprises a JAVA programming language type-2 connector and wherein the distributed application component comprises an Enterprise Java Bean (EJB) configured to receive or execute relational transaction requests for VSAM data in a transaction and return relational results using the connector and the distributed connector.

14. The apparatus of claim 9, wherein the EIS comprises a Multiple Virtual Storage Recoverable Resource Management Service (MVS/RRMS), a coupling facility (CF) and a VSAM Record Level Sharing (RLS) module that each interact with the RRM to provide logging, locking, two-phase commit, back out and sharing of the VSAM data such that transactions accessing the data by way of the RRM are recoverable.

15. A system for web-applications to access enterprise managed data, the system comprising:
a client application configured to interface with a web-application executing on a first application server;
a database module configured to interface with the web-application to allow relational database access to non-relational data; and
an enterprise information system configured to provide concurrent transactional access to the non-relational data as well as transactional recovery for the web-application as well as batch programs and Customer Information Control Systems (CICS).

16. The system of claim 15, wherein the non-relational data comprises Virtual Storage Access Method (VSAM) data.

17. The system of claim 15, wherein the web-application comprises one or more distributed middleware components executing on one or more application servers.

18. The system of claim 15, wherein the first application server executes on a z/OS operating system.

19. The system of claim 15, further comprising a second application server executing on an operating system that is not a z/OS operating system, the second application server in communication with the first application server, the system further comprising a distributed connecter that interfaces between a distributed application component on the second application server and the connecter executing on the first application server such that the distributed application component has transactional access to the VSAM data in which the transactions are managed using transactional recovery.

20. A method for web-applications to access enterprise managed data, the method comprising:
providing a recoverable resource manager (RRM) for data, the RRM configured to provide transactional recovery and transactional access for a plurality of transactions concurrently accessing the data;
converting a relational transaction involving the data managed by the RRM into a non-relational transaction;
communicating the non-relational transaction to the RRM to be executed in order to produce non-relational results; and
converting the non-relational results into relational results that are sent to a web-application.

21. The method of claim 20, wherein the RRM cooperates within an enterprise information system (EIS) to provide logging, locking, two-phase commit, back out and sharing of the data such that transactions accessing the data are recoverable.

22. The method of claim 20, further comprising receiving the relational transaction from the web-application according to an industry-accepted application programming interface (API).

23. The method of claim 20, wherein the RRM cooperates with a resource recovery service (RRS) and a Concurrent Access Facility (CAF) such that relational and non-relational transactions accessing the data are recoverable.

24. The method of claim 23, wherein the RRM comprises Storage Management Subsystem for Virtual Storage Access data (SMS VSAM) and the CAF comprises a coupling facility (CF).

25. The method of claim 20, wherein the RRM comprises a transactional Virtual Storage Access Method (transactional VSAM) module that uses VSAM Record Level Sharing (RLS) module and the data comprises VSAM data.

26. The method of claim 20, wherein converting the relational transaction comprises parsing the relational transaction into relational expressions and mapping the relational expressions to non-relational expressions according to predefined metadata defined by a relational view and a non-relational view of the data.

27. The method of claim 20, wherein converting the non-relational results comprises mapping the non-relational results to relational results according to predefined metadata defined by a relational view and a non-relational view of the data.

28. An article of manufacture comprising a program storage medium readable by a processor and embodying one or more instructions executable by a processor to perform a method for web-applications to access enterprise managed data, the method comprising:
providing a recoverable resource manager (RRM) for data, the RRM configured to provide transactional recovery and transactional access for a plurality of transactions concurrently accessing the data;
converting a relational transaction involving the data managed by the RRM into a non-relational transaction;
communicating the non-relational transaction to the RRM to be executed in order to produce non-relational results; and
converting the non-relational results into relational results that are sent to a web-application.

29. The article of manufacture of claim 28, wherein the RRM cooperates within an enterprise information system (EIS) to provide logging, locking, two-phase commit, back out and sharing of the data such that transactions accessing the data are recoverable.

30. The article of manufacture of claim 28, further comprising receiving the relational transaction from the web-application according to an industry-accepted application programming interface (API).

31. The article of manufacture of claim 28, wherein the RRM cooperates with a resource recovery service (RRS) and a Concurrent Access Facility (CAF) such that relational and non-relational transactions accessing the data are recoverable.

32. The article of manufacture of claim 31, wherein the RRM comprises Storage Management Subsystem for Virtual Storage Access data (SMS VSAM) and the CAF comprises a coupling facility (CF).

33. The article of manufacture of claim 28, wherein the RRM comprises a transactional Virtual Storage Access Method (transactional VSAM) module that uses VSAM Record Level Sharing (RLS) module and the data comprises VSAM data.

34. The article of manufacture of claim 28, wherein converting the relational transaction comprises parsing the relational transaction into relational expressions and mapping the relational expressions to non-relational expressions according to predefined metadata defined by a relational view and a non-relational view of the data.

35. The article of manufacture of claim 28, wherein converting the non-relational results comprises mapping the non-relational results to relational results according to predefined metadata defined by a relational view and a non-relational view of the data.

36. An apparatus for web-applications to access enterprise managed data, the method comprising:
means for providing a recoverable resource manager (RRM) for data, the RRM configured to provide transactional recovery and transactional access for a plurality of transactions concurrently accessing the data;
means for converting a relational transaction involving the data managed by the RRM into a non-relational transaction;
means for communicating the non-relational transaction to the RRM to be executed in order to produce non-relational results; and
means for converting the non-relational results into relational results that are sent to a web-application.

37. The apparatus of claim 36, wherein the RRM cooperates within an enterprise information system (EIS) to provide logging, locking, two-phase commit, back out and sharing of the data such that transactions accessing the data are recoverable.

38. The apparatus of claim 36, further comprising receiving the relational transaction from the web-application according to an industry-accepted application programming interface (API).

39. The apparatus of claim 36, wherein the RRM cooperates with a resource recovery service (RRS) and a Concurrent Access Facility (CAF) such that relational and non-relational transactions accessing the data are recoverable.

40. The method of claim 36, wherein converting the relational transaction comprises parsing the relational transaction into relational expressions and mapping the relational expressions to non-relational expressions and mapping the non-relational results to relational results where both mappings are accomplished according to predefined metadata defined by a relational view and a non-relational view of the data.
